(19) United States
(12) Patent Application Publication
(10) Pub. No.: US 2022/0241810 A1
(43) Pub. Date: Aug. 4, 2022

(54) COATING SYSTEM AND METHOD FOR A CONSTRUCTION WORK OR A CONSTRUCTION SITE

(71) Applicant: FIVEGRAND INTERNATIONAL CO., LTD., New Taipei City (TW)

(72) Inventor: TING-JUI WANG, New Taipei City (TW)

(21) Appl. No.: 17/582,020

(22) Filed: Jan. 24, 2022

(30) Foreign Application Priority Data
Feb. 2, 2021 (TW) 110103872

(51) Int. Cl. B05B 12/12; B05D 1/02; B05B 13/04; B05B 12/00; B05B 15/40

(52) U.S. Cl. CPC B05B 12/122; B05D 1/02; B05B 15/40; B05B 12/002; B05B 13/041

(57) ABSTRACT

A coating system applied for coating a target coating area with a coating material is disclosed. The coating system includes a carrier device, a coating structure and a control device. The coating structure is movably arranged on the carrier device. The control device controls the coating structure and has information corresponding to the target coating area, and the control device drives the coating structure according to the information to coat the target coating area with the coating material. The present invention further provides a method of use of a coating system.

### CROSS-REFERENCE TO RELATED APPLICATION

This present invention claims priority under 35 U.S.C. § 119(a) on invention application No(s). 110103872 filed in Taiwan, R.O.C. on Feb. 2, 2021, the entire contents of which are hereby incorporated by reference.

### BACKGROUND OF THE INVENTION

### 1. Field of the Invention

The present invention relates to a coating system and a method of use thereof, and in particular to a coating system that substitutes a machine for human labor and a method of use thereof.

### 2. Description of the Related Art

Current coating processes of coating materials such as paint, asphalt or cement mostly require manual operations, resulting in slow construction. Moreover, operation errors may frequently occur during manual operations, accordingly causing a waste in coating materials and delayed construction.

### BRIEF SUMMARY OF THE INVENTION

With extensive research and development, a coating system and a method of use thereof are provided in the aim of substituting a machine for human labor for coating, so as to prevent human errors.

According to a first aspect of the present invention, a coating system for a construction work is provided and applied for coating a target coating area of the construction work with a coating material. The coating system includes a carrier device, a coating structure and a control device. The coating structure is movably arranged on the carrier device. The control device controls the coating structure and has information corresponding to the target coating area, and the control device drives the coating structure according to the information to coat the target coating area with the coating material.

According to a second aspect of the present invention, a coating system for a construction site is provided and applied for coating a target coating area of the construction site with a coating material, and includes the coating system above.

According to a third aspect of the present invention, a method of use of a coating system for a construction work is provided, the method using the coating system above and including: obtaining information of the target coating area by the control device; and driving the coating structure according to the information to coat the target coating area with the coating material.

According to a fourth aspect of the present invention, a method of use of a coating system for a construction site is provided, the method using the coating system above and including: obtaining information of the target coating area by the control device; and driving the coating structure according to the information to coat the target coating area with the coating material.

In one embodiment, the control device is electrically connected to the coating structure, and the information that the control device has corresponding to the target coating area is coating information.

In one embodiment, the coating system further includes a motion mechanism connected on the carrier device, and the coating structure is connected to the motion mechanism.

In one embodiment, the motion mechanism is a slide bar to which the coating structure is slidably connected, and under driving of the control device, the coating structure moves vertically on the carrier device. Alternatively, the motion mechanism is a mechanical arm electrically connected to the control device, and the coating structure moves via the mechanical arm.

In one embodiment, the coating system further includes a servo motor electrically connected to the control device and the coating structure.

In one embodiment, a motion section is provided on a bottom portion of the carrier device to cause the carrier device to move according to path requirements of use.

In one embodiment, the coating system further includes an element that is in a signal connection with the control device, the motion section is controlled by the control device, and the control device controls the motion section to move via the signal connection with the element.

In one embodiment, the element is a magnetic track, a track having a signal transmitting/receiving function, or an element having a signal receiving or transmitting function.

In one embodiment, the coating system further includes at least one scanning or positioning device signally connected to the control device so as to scan and obtain map or geographic information of the target coating area, and the control device is configured to recognize the map or geographic information provided by the scanning or positioning device so as to send an instruction to the coating structure to perform coating.

In one embodiment, the scanning or positioning device is a two-dimensional scanning or positioning device, and the map or geographic information is two-dimensional map or geographic information; alternatively, the scanning or positioning device is a three-dimensional scanning or positioning device, the map or geographic information is three-dimensional map or geographic information.

In one embodiment, the scanning or positioning device is further for identifying whether the target coating area has been coated.

In one embodiment, the coating system further includes one or more position information sensors configured on one or more positions of the target coating area, and the control device is signally connected to the individual position information sensors to construct the information, wherein the information is map or geographic information.

In one embodiment, the target coating area includes a non-planar area, and the individual position information sensors are arranged on surfaces of at least two different angles in the non-planar area.

In one embodiment, the coating structure is rotatable relative to the carrier device so as to coat the target coating area including a planar or non-planar area.

In one embodiment, the individual position information sensors have constructed the map or geographic information with the control device before the coating structure performs coating, or have been removed from the target coating area before the coating structure performs coating.

In one embodiment, the coating system further includes an identification device. The identification device is arranged on the carrier device and is electrically connected to the control device, and is for identifying whether the target coating area has been coated. The identification device further sends a message to the control device, the control device recognized the message provided by the identification device and then issues an instruction to the coating structure, and the coating structure coats the target coating area according to the instruction.

In one embodiment, the identification device determines whether the target coating area has been coated or whether an expected coating effect is achieved by means of identifying a pattern, color, material, coating density or coating thickness of the target coating area.

In one embodiment, the identification device includes an image determination device, a scanning device or a combination thereof. The image determination device is for identifying the pattern or color of the target coating area, or the scanning device is for identifying the material, coating density or coating thickness of the target coating area.

In one embodiment, the scanning device includes an active or passive identification module that includes an active or passive infrared identification device, and the scanning device further includes a microwave identification device, a radar identification device or a magnetic identification device.

In one embodiment, the coating system further includes an elimination device and an identification device. The identification device determines whether the target coating area has been coated and sends a message to the control device, the control device recognized the message provided by the identification device and then issues an instruction to the coating structure, the coating structure coats the target coating area according to the instruction, and the elimination device is arranged around the identification device and is adapted to eliminate a substance that may affect identification performed by the identification device from the target coating area.

In one embodiment, the identification device is rotatable by 0 to 360 degrees, or an identifiable angle of the identification device is 0 to 360 degrees.

In one embodiment, the coating system further includes a particle suction device for sucking dust or a substance in the air in an ambient environment of the target coating area.

In one embodiment, the coating system further includes a particle discharge device or a combination including the particle discharge device and a filter device. The particle discharge device is in communication with the particle suction device, and the filter device is arranged between the particle suction device and the particle discharge device.

In one embodiment, the coating system further includes an alarm device arranged on the carrier device and electrically connected to the control device. The alarm device is for issuing a warning light or sound when the coating system malfunctions.

In one embodiment, the coating system further includes a storage tank and a pipeline connecting between the storage tank and the coating structure. The storage tank is for storing the coating material and supplying the coating material to the coating structure through the pipeline.

In one embodiment, the coating system further includes a flattening device connected to the control device. The flattening device is for flattening the coating material in the target coating area after the coating structure completes coating.

In one embodiment, when the coating structure continuously coats the target coating area with the coating material, the flattening device also continuously or non-continuously flattens the coating material in the target coating area.

In one embodiment, the coating system further includes a scraping device. The scraping device is for scraping off excess coating material on the flattening device when the flattening device completes flattening the coating material.

In one embodiment, the coating system further includes a receiving device. The receiving device is for receiving the coating material scraped off.

In one embodiment, the coating structure is a brush coating structure including a brush for applying the coating material, and the coating system further includes a storage tank and a pipeline connecting between the storage tank and the brush. The storage tank is for storing the coating material and transporting the coating material to the brush through the pipeline. Alternatively, the coating structure is further provided with a feed tank. The feed tank is located below the brush, and the pipeline connects between the feed tank and the storage tank so as to transport the coating material in the storage tank to the feed tank. Moreover, the brush is pivotally connected to a body of the coating structure so as to be pivotally rotated into the feed tank, and the brush enters the feed tank and is dipped with the coating material so as to coat the target coating area.

In one embodiment, the coating structure is a rolling coating structure including a roller for coating with the coating material, and the coating system further includes a feed tank and a pipeline connecting between the feed tank and the roller. The feed tank is for storing the coating material, and transporting the coating material to the roller through the pipeline. The coating system further includes a feed plate located on one end of the pipeline and arranged above the roller.

In one embodiment, the coating system further includes a first slide bar, a second slide bar and a slide beam. The first slide bar and the second slide bar are connected to the carrier device and are opposite to each other, two ends of the slide beam are respectively installed at the first slide bar and the second slide bar, and the slide beam is installed with the coating structure thereon.

In one embodiment, the coating system further includes a first slide bar and a slide beam. The slide beam is installed at the first slide bar, and the slide beam has the coating structure thereon or the slide beam is installed with the coating structure thereon.

In one embodiment, the slide beam, the first slide bar and the second slide bar have respective slide tracks, each of both ends of the slide beam is provided with a first slide block installed at the slide track of each of the first slide bar and the second slide bar, and the coating structure is provided with a second slide block installed at the slide track of the slide beam.

In one embodiment, the coating system further includes a driving device. The driving device is electrically connected to the coating structure, the slide beam and the control device, so as to control the slide beam to move up and down along the first slide bar or the second slide bar and to control the coating structure to move laterally or longitudinally along the slide beam.

In one embodiment, the coating system further includes a push frame. The push frame includes a connection section connected to one side of the carrier device and a handheld section connected to the connection section.

In one embodiment, the control device is for controlling the coating structure to perform matrix movement, longitudinal movement, lateral movement or rotational movement. The carrier device is located at a current position while the coating structure coats the target coating area, and the carrier device is adapted to be moved to another current position once the coating structure completes a coating task on the target coating area, so that the coating structure coats another target coating area.

In one embodiment, the carrier device is located at a current position while the coating structure coats the target coating area, and the carrier device is adapted to be moved to another current position once the coating structure completes a coating task on the target coating area, so that the coating structure coats another target coating area.

In one embodiment, the coating system further includes an identification device. The identification device is for capturing a plurality of images of the target coating area, the images are partially overlapping with one another so as to construct the information according to the images, and the information is two-dimensional or three-dimensional map or geographic information.

In one embodiment, the control device is installed with software for controlling a spray coating amount, spray coating speed or spray coating thickness of the coating material spray coated by the coating structure to the target coating area. Alternatively, the control device is signally connected to a remote device, the remote device is a computer or a mobile device, and the remote device is installed with the software when it is a computer or is installed with an application for controlling the software when it is a mobile device.

In one embodiment, a structure of a coating exit of the coating structure is for controlling a coating range or coating width of the coating material for coating.

In one embodiment, the control device is for controlling the coating structure to perform matrix movement, longitudinal movement, lateral movement or rotational movement. The coating structure is located at a current position while it coats the target coating area, and the coating structure is adapted to be moved to another current position once it completes a coating task on the target coating area, so that the coating structure coats another target coating area. Alternatively, the control device is for controlling the coating structure to move among different current positions in response to a coating sequence corresponding to different target coating areas.

In one embodiment, the coating structure is located at a current position while it coats the target coating area, and the coating structure is adapted to be moved to another current position once it completes a coating task on the target coating area, so that the coating structure coats another target coating area.

In one embodiment, the control device is for synchronously controlling the coating structure and the carrier device to perform matrix movement, longitudinal movement, lateral movement or rotational movement. The coating structure and the carrier device are located at a current position while the coating structure coats the target coating area, and the coating structure and the carrier device are adapted to be moved to another current position once they complete a coating task on the target coating area, so that the coating structure and the carrier device coat another target coating area. Alternatively, the control device is for controlling the carrier device and the coating structure to move among different current positions in response to a coating sequence of the coating structure corresponding to different target coating areas.

In one embodiment, the control device is for controlling the coating device to perform matrix movement, longitudinal movement, lateral movement or rotational movement.

In one embodiment, when the carrier device or the coating device is still, the control device is adapted to constantly or intermittently control the carrier device or the coating device to be kept at a predetermined distance from the target coating area. When the carrier device or the coating structure is in motion, the control device is adapted to constantly or intermittently control the carrier device or the coating device to maintain a cruise distance from the target coating area.

In one embodiment, the coating material includes water-based paint, oil-based paint, cement, resin, glue, Teflon, oil, paint, colored material, colorless material or asphalt, or other liquid or semi-liquid paint.

Thus, the coating system and the method of use thereof of the present invention are capable of driving the coating structure according to the map information of the control device to coat the target coating area with the coating material, so as to prevent human operation errors.

### BRIEF DESCRIPTION OF THE DRAWINGS

FIG. 1A is a first schematic diagram of a coating system according to a specific embodiment of the present invention.

FIG. 1B is a second schematic diagram of a coating system according to a specific embodiment of the present invention.

FIG. 1C is a third schematic diagram of a coating system according to a specific embodiment of the present invention.

FIG. 1D is a fourth schematic diagram of a coating system according to a specific embodiment of the present invention.

FIG. 2 is a fifth schematic diagram of a coating system according to a specific embodiment of the present invention.

FIG. 3A is a sixth schematic diagram of a coating system according to a specific embodiment of the present invention.

FIG. 3B is a seventh schematic diagram of a coating system according to a specific embodiment of the present invention.

FIG. 3C is a schematic diagram of position information sensors displayed on a control device according to a specific embodiment of the present invention.

FIG. 4A is a schematic diagram of position information sensors arranged in a non-planar target coating area according to a specific embodiment of the present invention.

FIG. 4B is a schematic diagram of position information sensors arranged in a non-planar target coating area and displayed on a control device according to a specific embodiment of the present invention.

FIG. 5A is a first schematic diagram of an operation of a coating structure coating a non-planar target coating area according to a specific embodiment of the present invention.

FIG. 5B is a second schematic diagram of an operation of a coating structure coating a non-planar target coating area according to a specific embodiment of the present invention.

FIG. 5C is a third schematic diagram of an operation of a coating structure coating a non-planar target coating area according to a specific embodiment of the present invention.

FIG. 6 is a schematic diagram of a coating structure connected to a servo motor according to a specific embodiment of the present invention.

FIG. 7 is an eighth schematic diagram of a coating system according to a specific embodiment of the present invention.

FIG. 8 is a ninth schematic diagram of a coating system according to a specific embodiment of the present invention.

FIG. 9A is an exploded schematic diagram of a coating system according to a specific embodiment of the present invention.

FIG. 9B is a tenth schematic diagram of a coating system according to a specific embodiment of the present invention.

FIG. 10A is an eleventh schematic diagram of a coating system according to a specific embodiment of the present invention.

FIG. 10B is a twelfth schematic diagram of a coating system according to a specific embodiment of the present invention.

FIG. 11A is a first schematic diagram of an operation of a flattening device according to a specific embodiment of the present invention.

FIG. 11B is a second schematic diagram of an operation of a flattening device according to a specific embodiment of the present invention.

FIG. 11C is a first schematic diagram of operations of a flattening device, a scraping device and a receiving device according to a specific embodiment of the present invention.

FIG. 11D is a second schematic diagram of operations of a flattening device, a scraping device and a receiving device according to a specific embodiment of the present invention.

FIG. 12A is a thirteenth schematic diagram of a coating system according to a specific embodiment of the present invention.

FIG. 12B is a fourteenth schematic diagram of a coating system according to a specific embodiment of the present invention.

FIG. 13 is a schematic diagram of a pipeline supplying a coating material to a brush coating structure according to a specific embodiment of the present invention.

FIG. 14 is a fifteenth schematic diagram of a coating system according to a specific embodiment of the present invention.

FIG. 15A is a schematic diagram of a pipeline supplying a coating material to a rolling coating structure according to a specific embodiment of the present invention.

FIG. 15B is a schematic diagram of a rolling coating structure receiving a coating material through a feed plate according to a specific embodiment of the present invention.

FIG. 16A is a sixteenth schematic diagram of a coating system according to a specific embodiment of the present invention.

FIG. 16B is a seventeenth schematic diagram of a coating system according to a specific embodiment of the present invention.

FIG. 16C is a schematic diagram of an identification device and a coating structure according to a specific embodiment of the present invention.

FIG. 16D is a schematic diagram of an identification device pivotally connected to a motion mechanism according to a specific embodiment of the present invention.

FIG. 16E is a first flowchart of a method of use of a coating system according to a specific embodiment of the present invention.

FIG. 17 is a second flowchart of the method of use of a coating system according to a specific embodiment of the present invention.

FIG. 18A is a first schematic diagram of a coating system connected to a remote device according to a specific embodiment of the present invention.

FIG. 18B is a second schematic diagram of a coating system connected to a remote device according to a specific embodiment of the present invention.

FIG. 19 is an eighteenth schematic diagram of a coating system according to a specific embodiment of the present invention.

FIG. 20 is a schematic diagram of an identifiable track and a carrier device according to a specific embodiment of the present invention.

FIG. 21 is a nineteenth schematic diagram of a coating system according to a specific embodiment of the present invention.

FIG. 22 is a first schematic diagram of an identification device performing capturing according to a specific embodiment of the present invention, and

FIG. 23 is a second schematic diagram of an identification device performing capturing according to a specific embodiment of the present invention.

### DETAILED DESCRIPTION OF THE INVENTION

To fully understand the objects, features and effects of the present invention, the present invention is described in detail by way of the specific embodiments with the accompanying drawings below.

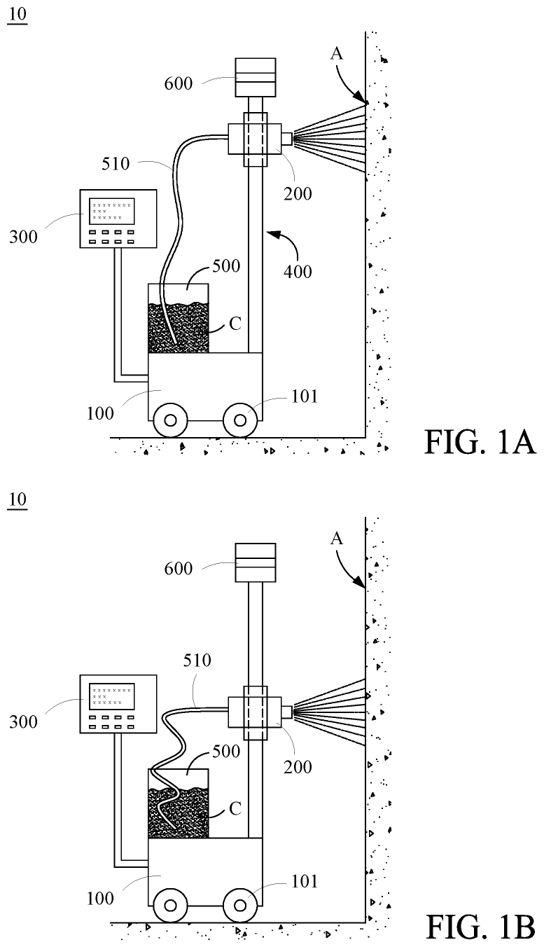

Referring to FIG. 1A to FIG. 1D, according to a first aspect of the present invention, a coating system 10 for a construction work is provided and applied for coating a target coating area A with a coating material C. The coating system 10 includes a carrier device 100, a coating structure 200 and a control device 300. The coating structure 200 is movably arranged on the carrier device 100. The control device 300 controls the coating structure 200 and has information corresponding to the target coating area A, and the control device 300 drives the coating structure 200 according to the information to coat the target coating area A with the coating material C. Specifically, the control device 300 is electrically connected to the coating structure 200, and the information may be map information corresponding to the target coating area A. However, the present invention is not limited to the examples above; for example, the information may also be image information or identifiable signal information to be described in the embodiments below. The information may be, for example but not limited to, stored in advance in the control device 300. The carrier device 100 may be, for example but not limited to, a platform or a frame.

According to a second aspect of the present invention, a coating system for a construction site is provided and applied for coating a target coating area of the construction site with a coating material, and includes the coating system 10 above.

According to a third aspect of the present invention, a method of use of a coating system for a construction work is provided, the method using the coating system 10 above and including: obtaining, by the control device 300, information of the target coating area A; and driving the coating structure 200 according to the information to coat the target coating area A with the coating material C.

According to a fourth aspect of the present invention, a method of use of a coating system for a construction site is provided, the method using the coating system 10 above and including: obtaining, by the control device 300, information of the target coating area A; and driving the coating structure 200 according to the information to coat the target coating area A with the coating material C.

As described above, the coating system 10 and the method of use thereof of the present invention are capable of driving the coating structure 200 according to the information of the control device 300, so as to coat the target coating area A with the coating material C and to substitute a machine for human labor and thus preventing human operation errors.

In one embodiment, the control device 300 is a computer, tablet computer, cell phone, application device, artificial intelligence device, network device or remote controller. The control device 300 may be installed with at least a set of software including software for controlling the coating system 10, image recognition software, neural network or graph comparison software, two-dimensional construction software or three-dimensional construction software, so as to control all devices in the coating system 10. The control device 300 may also be installed with software to control a spray coating amount, spray coating speed or spray coating thickness of the coating material spray coated by the coating structure to the target coating area. The control device 300 may also be signally connected to a remote device. The remote device may be a computer or a mobile device. The remote device is installed with the software when it is the computer, and is installed with an application (APP) for controlling the software when it is the mobile device.

In one embodiment, the coating material C includes water-based paint, oil-based paint, cement, resin, glue, Teflon, oil, paint, colored material, colorless material or asphalt, or other liquid or semi-liquid paint.

In one embodiment, a structure of a coating exit of the coating structure 200 is for controlling a spray coating range or coating width of the coating material C for coating.

As shown in FIG. 1A to FIG. 1D, in one embodiment, the coating system 10 further includes a motion mechanism 400 connected on the carrier device 100, and the coating structure 200 is connected to the motion mechanism 400. The motion mechanism 400 may be a slide bar to which the coating structure 200 is slidably connected, and under driving of the control device 300, the coating structure 200 moves, for example but not limited to, vertically on the carrier device 100.

As shown in FIG. 1A to FIG. 1D, in one embodiment, the coating system 10 further includes a storage tank 500 arranged on the carrier device 100 and a pipeline 510 connecting between the storage tank 500 and the coating structure 200. The storage tank 500 is for storing the coating material C and supplying the coating material C to the coating structure 200 through the pipeline 510.

As shown in FIG. 1A to FIG. 1D, in one embodiment, a motion section 101 is provided on a bottom portion of the carrier device 100 to cause the carrier device 100 to move according to path requirements of use. The motion section 101 includes a plurality of wheels, and a user may move the carrier device 100 after the coating task is complete or according to operation requirements, so as to allow the coating structure 200 to move to positions in front of different target coating areas A. The carrier device 100 may perform motion in a lateral, longitudinal or an arbitrary direction through the motion section 101, for example, moving along a plane parallel to the target coating area A. The control device 300 is for providing a motion instruction to the motion section 101 and providing a coating instruction to the coating structure 200. The motion instruction is for controlling a movement position, movement distance and movement direction of the motion section 101, and the motion instruction may be integrated with the coating instruction so as to control a coating sequence of the coating structure 200 with respect to the target coating area A or to adjust a control relationship between coating instructions.

As shown in FIG. 1A to FIG. 1D, in one embodiment, the coating system 10 further includes an alarm device 600 arranged on the carrier device 100 and electrically connected to the control device 300. The alarm device 600 is for issuing a warning light or sound when the coating system 10 malfunctions. For example, the alarm device 600 is a warning light, a beeper or an alarm device combining the two functions above. The alarm device 600 may be arranged, for example but not limited to, on a top portion of the motion mechanism 400 of the slide bar, so as to facilitate the user to timely notice any abnormal situations.

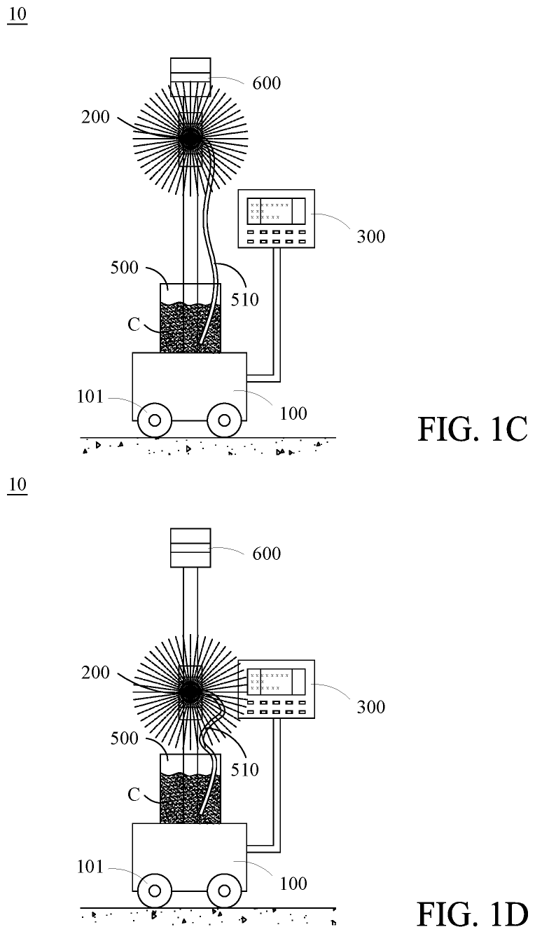

As shown in FIG. 2, in one embodiment, the coating system 10 further includes at least one scanning or positioning device 700 signally connected to the control device 300 so as to scan and obtain information of the target coating area A. At this point in time, the information obtained by scanning is map or geographic information. The at least one scanning or positioning device 700 may be arranged on the carrier device 100, for example, integrally provided at the control device 300. The at least one scanning or positioning device 700 may be separated from the carrier device 100. In order to provide more accurate map or geographic information, the at least one scanning or positioning device 700 may include one that is arranged on the carrier device 100 and one that is separated from the carrier device 100. The scanning or positioning device 700 may be a two-dimensional scanning or positioning device, and the map or geographic information is two-dimensional map or geographic information; alternatively, the scanning or positioning device 700 may be a three-dimensional scanning or positioning device, and the map or geographic information is three-dimensional map or geographic information. The scanning or positioning device 700 may be, for example but not limited to, an infrared range finder or an ultrasonic range finder.

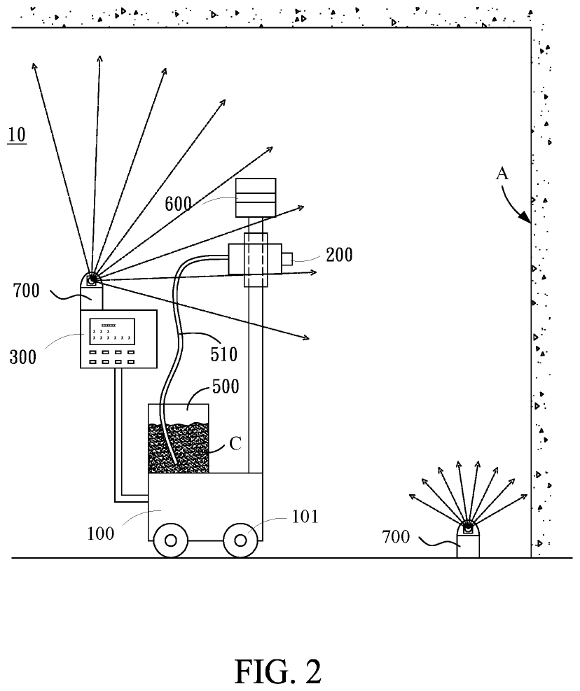

As shown in FIG. 3A to FIG. 3C, in one embodiment, the coating system 10 further includes one or more position information sensors 11 configured on one or more positions of the target coating area A, and the control device 300 is signally connected to the individual position information sensors 11 to construct the information. At this point in time, the constructed information is map or geographic information. For example, in FIG. 3B, the position information sensors 11 at the three positions including points B1, B2 and B3 and the control device 300 establish the map or geographic information. Each of the position information sensors 11 may be an infrared sensor, and the control device 300 may have a function of transmitting infrared light; alternatively, each of the position information sensors 11 may be an ultrasonic sensor, and the control device 300 may have a function of transmitting ultrasonic waves; however, the present invention is not limited to the examples above. In response to different coating requirements, the map or geographic information constructed by the position information sensors 11 and the control device 300 may be two-dimensional map or geographic information or three-dimensional map or geographic information. Through a screen of the control device 300, the user may also view conditions of the position information sensors 11 constructing the map or geographic information. To prevent from affecting the coating operation, the position information sensors 11 may have constructed the map or geographic information with the control device 300 before the coating structure 200 performs coating, or have been removed from the target coating area A before the coating operation.

As shown in FIG. 3A, in one embodiment, the control device 300 is for controlling the coating structure 200 to perform matrix movement, longitudinal movement, lateral movement or rotational movement. The carrier device 100 is located at a current position POS1 while the coating structure 200 coats a target coating area A1, and the carrier device 100 is adapted to be moved to another current position POS2 once the coating structure 200 completes a coating task on the target coating area A1, so that the coating structure 200 is caused to coat another target coating area A2. Similarly, the coating structure 200 can be next moved to a current position POS3 to coat a target coating area A3. The control device 300 may be used control the carrier device 100 to move among different current positions in response to a coating sequence of the coating structure 200 corresponding to different target coating areas. For example but not limited to, the control device 300 may move the carrier device 100 by controlling the motion section 101, or the user may manually push the carrier device 100. However, the control device 300 may control only the coating structure 200 to move among different current positions.

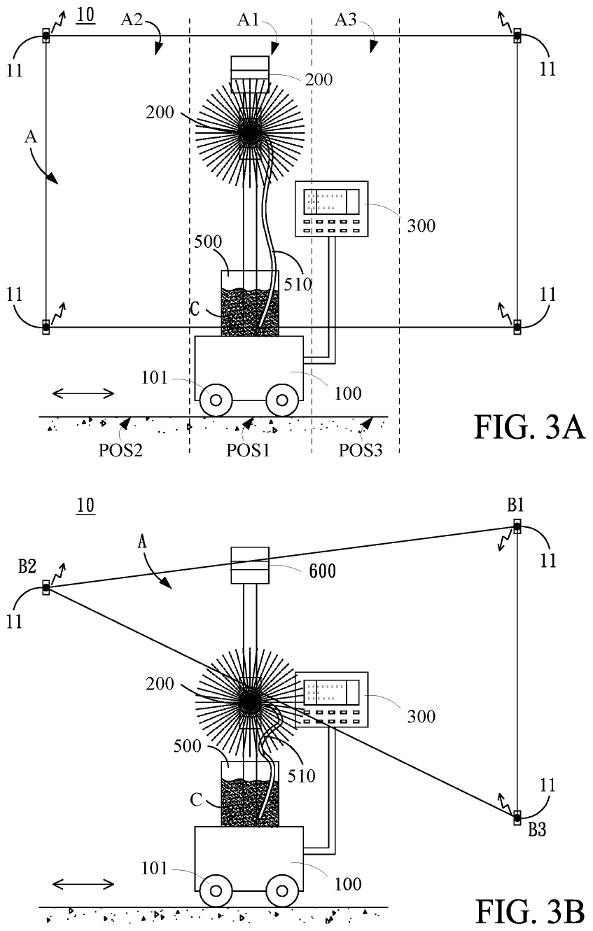

As shown in FIG. 4A to FIG. 4B, in one embodiment, the target coating area A includes a non-planar area, for example, a first plane P1 and a second plane P2, and at this point in time, the individual position information sensors 11 may be arranged on the first plane P1 and the second plane P2. Similarly, through the screen of the control device 300, the user may also view conditions of the position information sensors 11 constructing the map or geographic information.

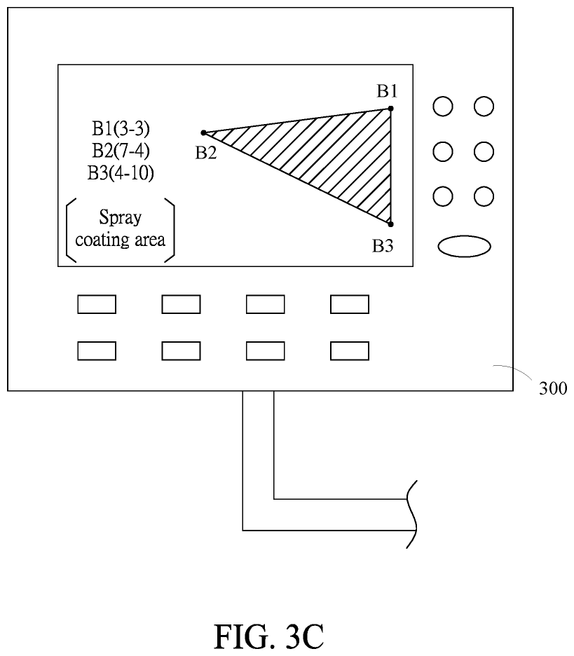

As shown in FIG. 1A and FIG. 5A to FIG. 5C, in one embodiment, the coating structure 200 is rotatable relative to the carrier device 100 in response to a non-planar coating area A, so as to coat the target coating area A. The coating structure 200 may be, for example but not limited to, pivotally connected to the motion mechanism 400 that is a slide bar. It should be noted that, the coating structure 200 rotatable relative to the carrier device 100 may also coat a planar target coating area A.

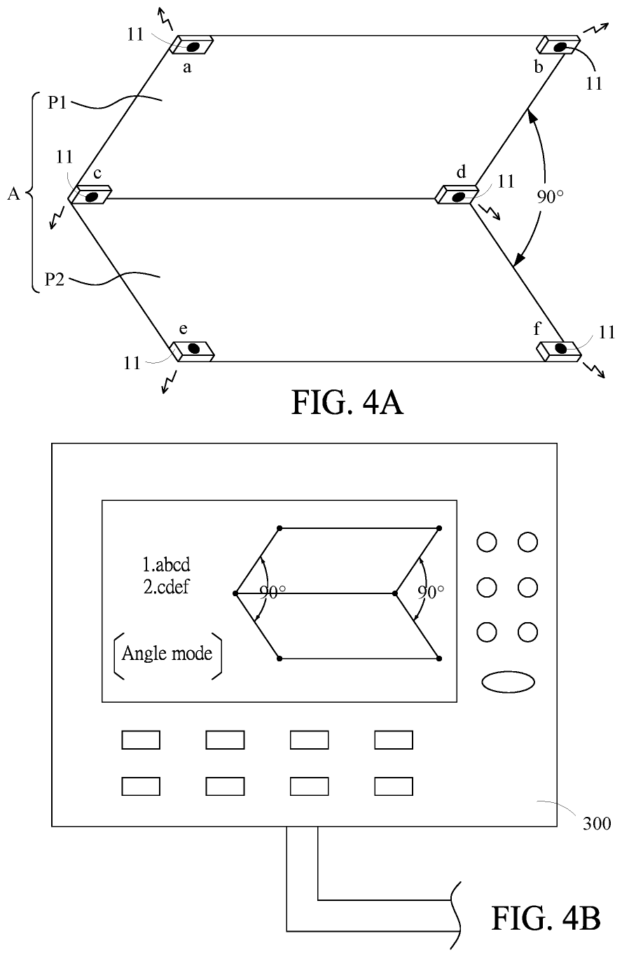

As shown in FIG. 1A and FIG. 6, in one embodiment, the coating system 10 further includes a servo motor 12. The servo motor 12 is electrically connected to the control device 300, and is electrically connected to the coating structure 200 by a transmission line 121, so as to control the coating structure 200 to move reciprocally along the motion mechanism 400 that is a slide bar. The pipeline 510 passes through the coating structure 200 and is in communication with an exit 205 of the coating structure 200.

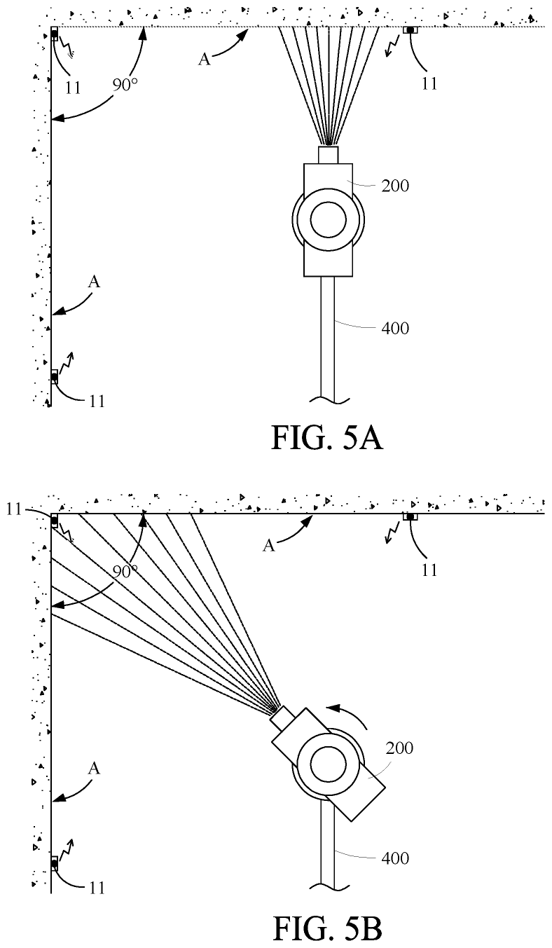

As shown in FIG. 7, in one embodiment, the motion mechanism 400 may also a mechanical arm electrically connected to the control device 300, and the coating structure 200 moves via the mechanical arm.

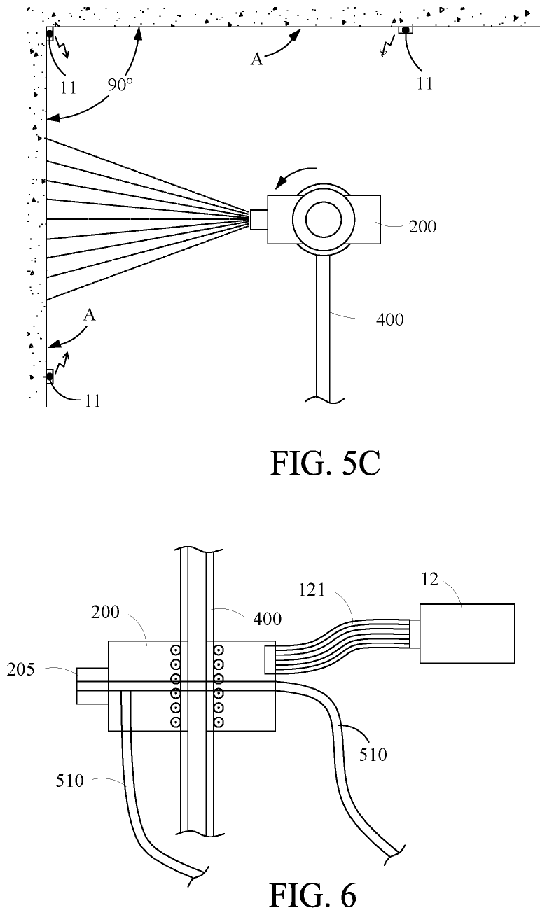

As shown in FIG. 8, in one embodiment, the coating system 10 may further include a power device 13, which is electrically connected to the coating structure 200 and serves as a power source of the coating structure 200. The power device 13 may be, for example but not limited to, a rechargeable electric motor and has a plug 131 for plugging with a socket (not shown). In other embodiments that are not depicted by the drawings, the power device 13 may also be a battery motor, a plug-in motor, a fuel-driven motor, a pneumatic power unit or a hydraulic power unit.

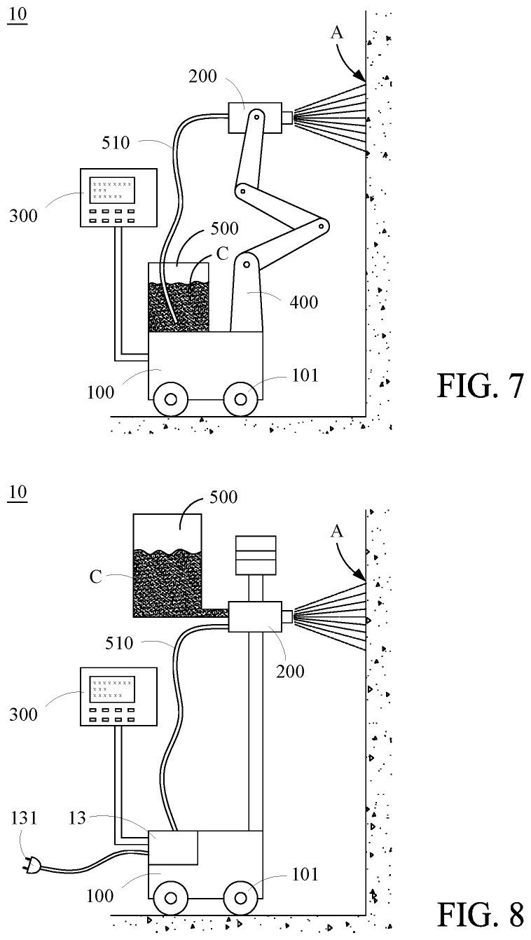

As shown in FIG. 9A and FIG. 9B, in one embodiment, the coating system 10 may be an assembled system. For example, the motion mechanism 400 may be divided into a first rod 401, a second rod 402 and a third rod 403, the coating structure 200 and the alarm device 600 are similarly assembled at the motion mechanism 400, and the storage tank 500 and the pipeline 510 may also be separated from the carrier device 100. Thus, the coating system 10 is allowed to be more readily transferred to different locations to perform a coating operation. For example, the motion mechanism 400 may be assembled into an assembled structure of different heights and dimensions so as to be assembled to have different heights or dimensions in response to different coating environments, and may be disassembled into multiple sections with smaller heights and dimensions when no longer in use, so as to be easily loaded onto a transportation vehicle and then be later assembled into a structure having a height or dimensions adapted to a new coating environment when transported to a new application site.

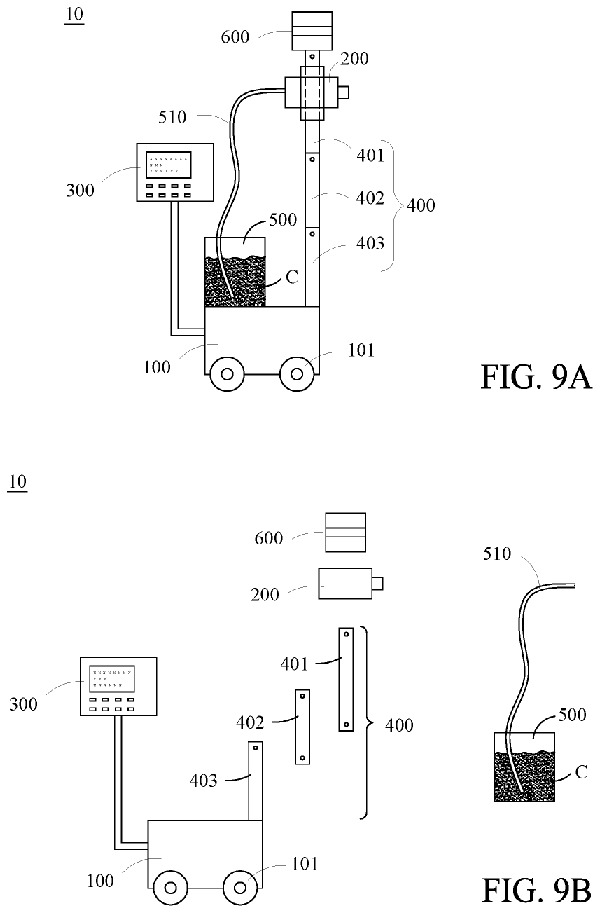

As shown in FIG. 10A and FIG. 10B, in one embodiment, the coating structure 200 of the coating system 10 may be a coating structure in form of a nozzle to coat the target coating area A with the coating material C. The coating system 10 further includes a flattening device 800 electrically connected to the control device 300. The flattening device 800 is for flattening the coating material C on the target coating area A after the coating structure 200 completes spray coating. The coating structure 200 and the flattening device 800 are both electrically connected to the control device 300 by the transmission line 121. At this point in time, the control device 300 may be integrated with the servo motor 12 shown in FIG. 7, so as to control the flattening device 800 to move vertically along the motion mechanism 400. The flattening device 800 may include, for example but not limited to, a scraper. When the coating structure 200 continuously coats the target coating area A with the coating material C, the flattening device 800 also continuously or non-continuously flattens the coating material C on the plane of the target coating area A

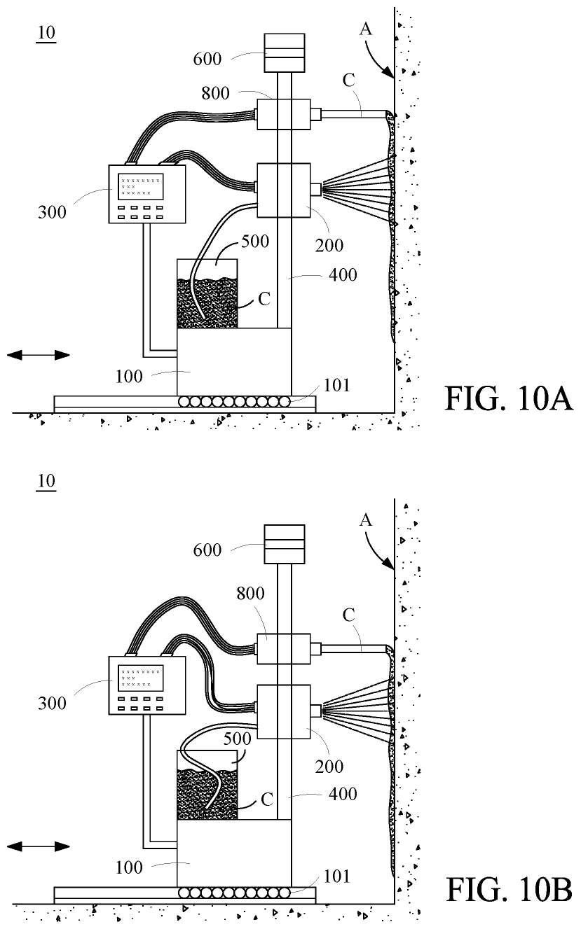

Referring to FIG. 11A to FIG. 11D, as shown in FIG. 11A and FIG. 11B, when an excess amount of coating material C is accumulated on the flattening device 800, the flattening device 800 may be rotated by 90 degrees. As shown in FIG. 11C, the coating system 10 may further include a scraping device 14 and a receiving device 15. The scraping device 14 is, for example, a plate, so as to scrape off excess coating material C from the flattening device 800 when the flattening device 800 completes flattening the coating material C. The receiving device 15 is a container for receiving the coating material C that is scraped off. As shown in FIG. 11D, once the excess coating material C is scraped off, the flattening device 800 may be rotated back to an original operating angle.

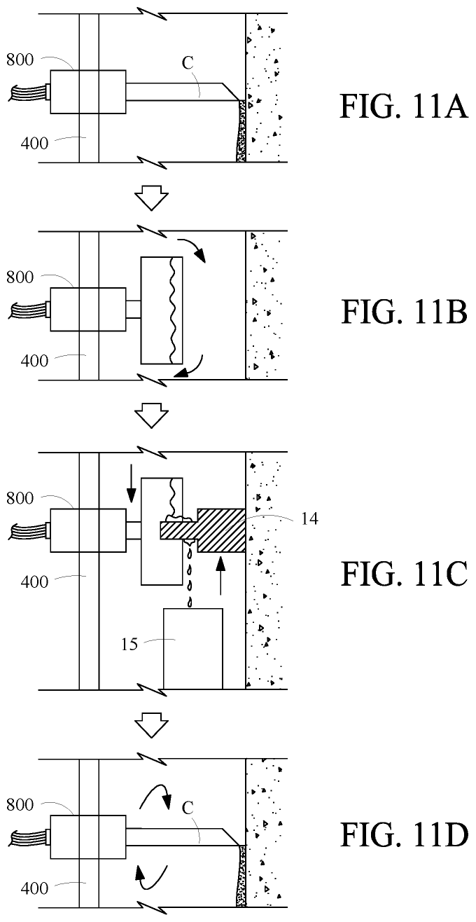

As shown in FIG. 12A and FIG. 12B, in one embodiment, the coating structure 200 may be a brush coating structure including a brush 201 for applying the coating material C. Similar to the foregoing embodiments, the coating system 10 may transport the coating material C stored in the storage tank 500 to the brush 201 through the pipeline 510. The coating structure 200 may be further provided with a feed tank 202 that is located below the brush 201. The pipeline 510 connects between the feed tank 202 and the storage tank 500, so as to transport the coating material C in the storage tank 500 to the feed tank 202. Moreover, the brush 201 is pivotally connected to a body 203 of the coating structure 200. The body 203 may be a mechanical assembly slidably connected to the motion mechanism 400 and electrically connected to the control device 300. The brush 201 may enter the feed tank 202 and be dipped with the coating material C so as to coat the target coating area A. It should be noted that the present invention is not limited to the examples above. Referring to FIG. 11A to FIG. 11D, the coating structure 200 of this embodiment may also operate in coordination with the flattening device 800, the scraping device 14 and the receiving device 15.

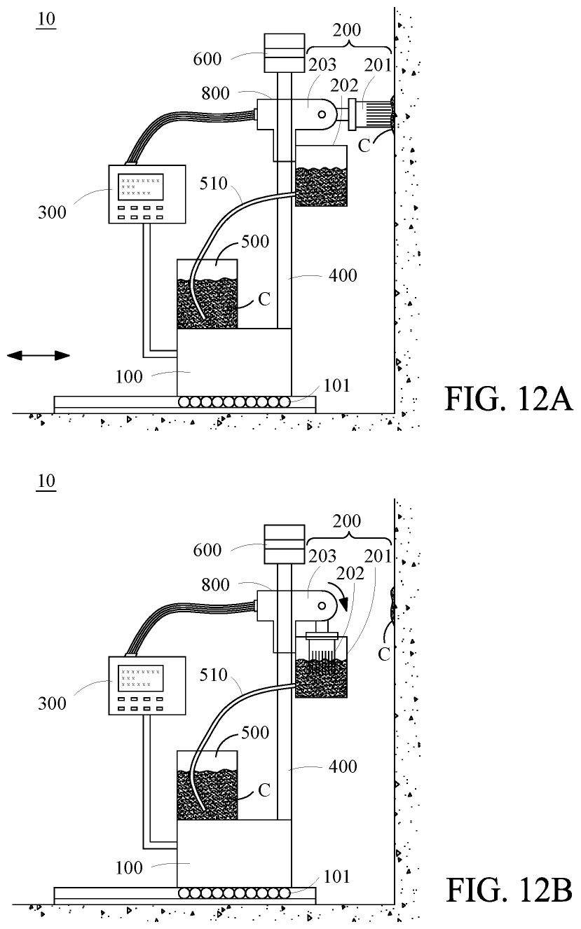

As shown in FIG. 12A and FIG. 13, in one embodiment, the pipeline 510 may also directly transport the coating material C to the brush 201.

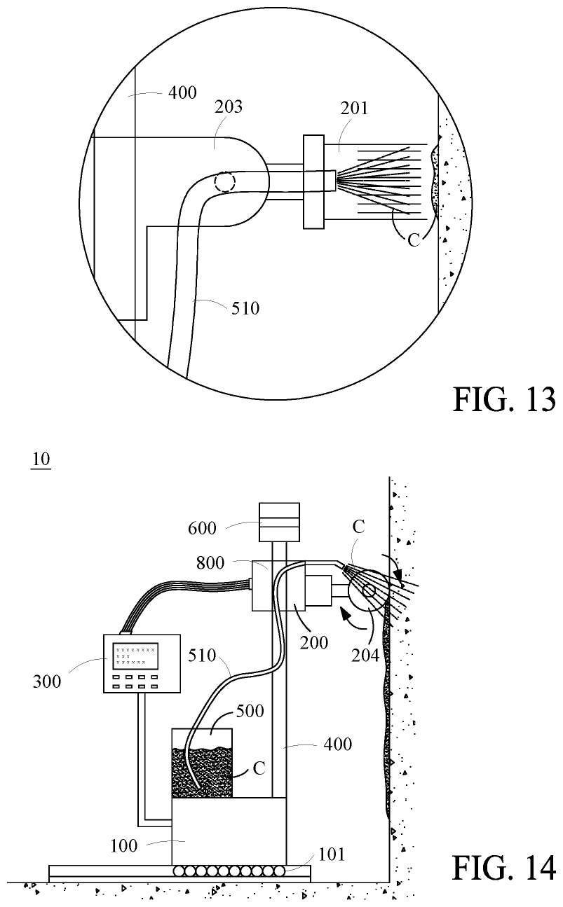

As shown in FIG. 14, in one embodiment, the coating structure 200 may be a rolling coating structure including a roller 204 for applying the coating material C, and similar to the foregoing embodiments, the coating system 10 may transport the coating material C stored in the storage tank 500 to the roller 204 through the pipeline 510.

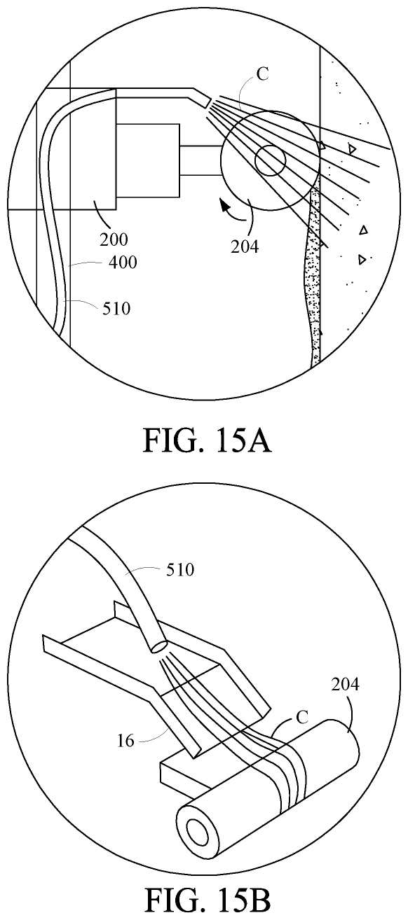

As shown in FIG. 15A and referring to FIG. 14, in one embodiment, the pipeline 510 may also directly supply the coating material C to the roller 204.

As shown in FIG. 15B and referring to FIG. 14, in one embodiment, the coating system 10 may further include a feed plate 16, which is located on one end of the pipeline 510 and arranged above the roller 204. Accordingly, the coating material C can be more evenly distributed on the roller 204.

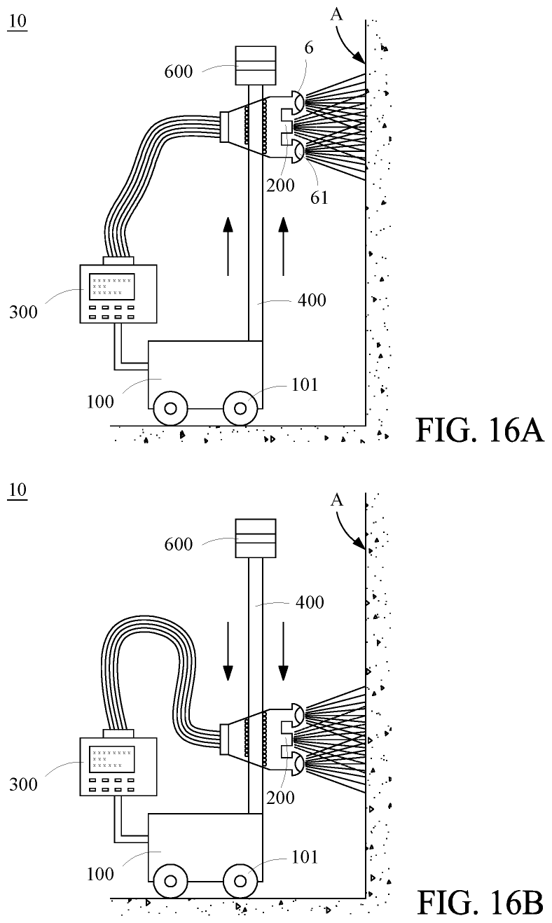

Referring to FIG. 16A to FIG. 16E, in one embodiment, the coating system 10 further includes an identification device 6. The identification device 6 may be arranged on the carrier device 100 and be electrically connected to the control device 300, so as to identify whether the target coating area A has been coated. Specifically, the identification device 6 may be an image determination device so as to provide image information. For example, the image determination device is a (video) camera, which includes a lens 61. The (video) camera may also be, for example but not limited to, an assembly that includes the lens 61 and a photosensitive coupling element (not shown) or a complementary metal oxide semiconductor (CMOS) element (not shown) coordinating with the lens 61, so as to identify a pattern or color of the target coating area A. The identification device 6 may also include a scanning device (not shown) to provide identifiable information. The scanning device may be similar to the scanning and positioning device 700 in FIG. 2. The scanning device may be used to identify a material, coating density or coating thickness of the target coating area A. It should be noted that, according to different coating requirements, the identification device 6 may also include the scanning device and the image determination device, so as to determine whether the target coating area A has been coated or whether an expected coating effect is achieved by means of identifying a pattern, color, material, coating density or coating thickness of the target coating area A at the same time. The scanning device may include an active or passive identification device that respectively includes an active or passive infrared identification device, and the scanning device may further include a microwave identification device, a radar identification device or a magnetic identification device. The software installed on the control device 300 may be software for controlling the coating system 10, image recognition software, neural network, graph comparison software, two-dimensional construction software or three-dimensional construction software, so as to perform identification in coordination with the image determination device or the scanning device.

As shown in FIG. 16A and FIG. 16B, in one embodiment, the identification device 6 may be connected to the coating structure 200 so as to be moved along with the coating structure 200, for example but not limited to, moving vertically along the motion structure 400. Moreover, the identification device 6 may also be arranged on another part of the carrier device 100 and is not moved in conjunction with the coating structure 200.

Referring to FIG. 16A to FIG. 16C, in one embodiment, the coating system 10 further includes an elimination device 62. The elimination device 62 is arranged around the identification device 6 and is electrically connected to the control device 300. The elimination device 62 is adapted to eliminate substances that affect the identification performed by the identification device 6 from the target coating area A, for example, dust, insects or spider webs. The elimination device 62 may be an air outlet device such as a fan, a water spray device such as a nozzle, or a scrubbing device such as an electric brush. Moreover, with the control of the control device 300, the elimination device 62 may also be repeatedly turned on an off in coordination with the identification device 6.

As shown in FIG. 16D, in one embodiment, the identification device 6 is rotatable by 360 degrees, and the identification device 6 may be pivotally connected to the motion mechanism 400 and be rotatable by 0 degree to 360 degrees relative to the motion mechanism 400. It should be noted that the present invention is not limited to the examples above. For example, the identification device 6 may also be the foregoing image determination device having a 0-degree to 360-degree lens, or the foregoing scanning device having a 0-degree to 360-degree scanning angle.

As shown in FIGS. 16A, 16B and 16E, in step S101, the identification device 6 may provide a message to the control device 300 after identifying the target coating area A; in step S102, the control device 300 recognized the message provided by the identification device 6 and then issues an instruction to the coating structure 200; in step S103, the coating structure 200 coats the target coating area A according to the instruction. Step S104 is then performed to end the coating operation.

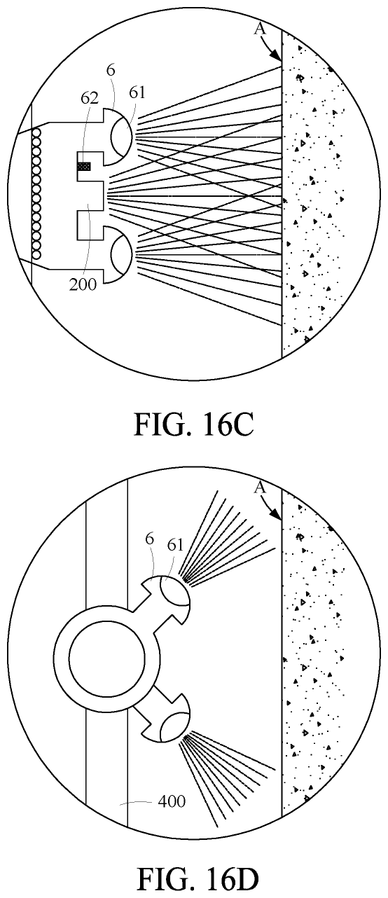

As shown in FIG. 17 and FIG. 2, in one embodiment, the scanning or positioning device 700 may also be used to identify whether the target coating area A has been coated. In step S201, the scanning or positioning device 700 may provide a message to the control device 300 after identifying the target coating area A; in step S202, the control device 300 recognized the message provided by the scanning or positioning device 700 and then issues an instruction to the coating structure 200; in step S203, the coating structure 200 coats the target coating area A according to the instruction. Step S204 is then performed to end the coating operation. It is known from the description above that, the scanning or positioning device 700 may be a two-dimensional scanning or positioning device or a three-dimensional scanning or positioning device.

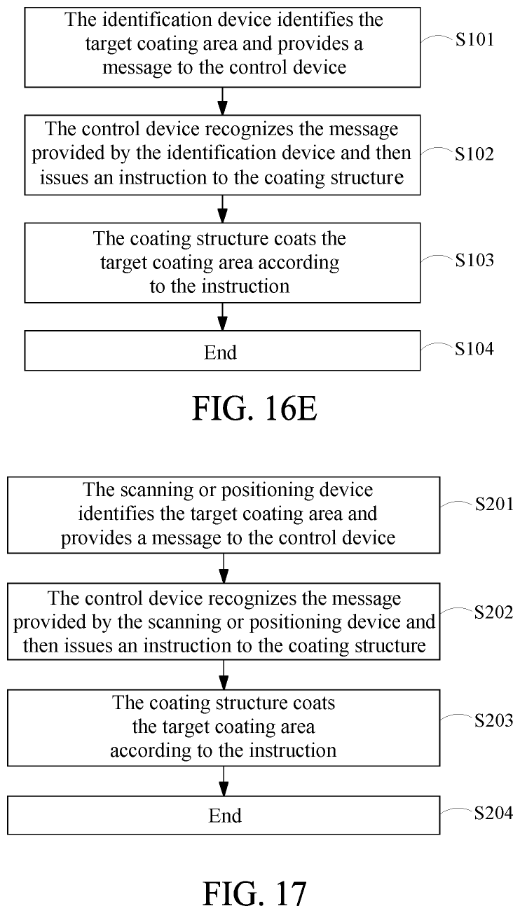

As shown in FIG. 18A and FIG. 18B, in one embodiment, the control device 300 of the coating system 10 may be connected to a remote device 18. The remote device 18 can remotely control the control device 300 so as to activate the coating system 10. For example, in FIG. 18A, the remote device 18 is remotely connected to the coating system 10 having the identification device 6. Alternatively, for example, in FIG. 18B, the remote device 18 is remotely connected to the coating system 10 having the scanning or positioning device 700 with an identification function. Once the coating system 10 is activated by the remote device 18, the coating process as shown in FIG. 16E or FIG. 17 can be performed. The remote device 18 may be a personal computer, laptop computer, cell phone or server. The remote connection may by implemented by the WiFi or Bluetooth technology.

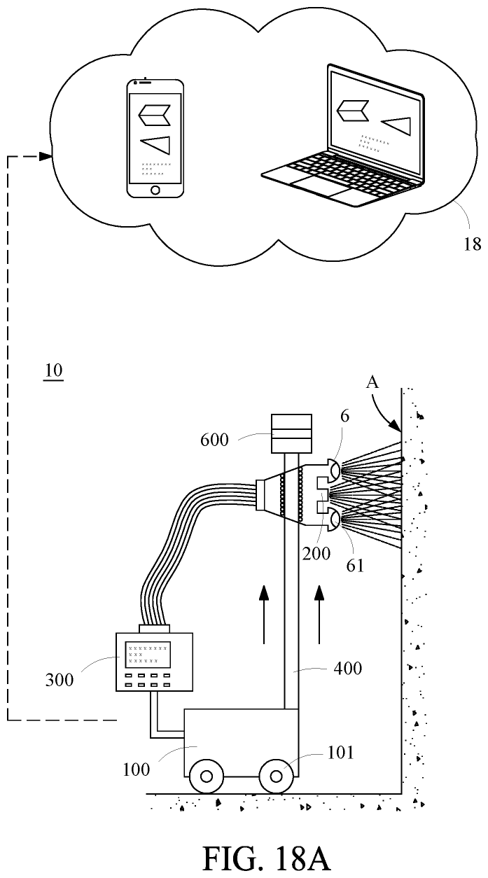

Referring to FIG. 19, in one embodiment, the coating system 10 may further include a particle suction device 19. The particle suction device 19 is, for example, arranged on one side of the carrier device 100 to suck dust or substances in the air in an ambient environment of the target coating area A. When the coating structure 200 performs coating, for example, spray coating, dust is inevitably raised or impurities such as excess coating materials are generated. If the dust and impurities above are not cleaned up timely, and increased amount of impurities and dust may be generated when the target coating area A is in an indoor space, the human health or electronic facilities of the coating system 10 may be damaged. The particle suction device 19 is capable of timely sucking the dust and impurities. The coating system 10 may further include a filter device 20 and a particle discharge device 21. The particle discharge device 21 is, for example, arranged on one side of the carrier device 100 or is in communication with the particle suction device 19. The filter device 20 may be arranged between the particle suction device 19 and the particle discharge device 21 so as to filter out more granular impurities or dust and prevent congestion of the particle discharge device 21. The impurities or dust not filtered out by the filter device 20 are discharged by the particle discharge device 21 from the ambient space of the target coating area A. The particle suction device 19 may include a particle collecting container 191, a particle suction pipeline 192 and a fan group 193. The particle collecting container 191 may be located below the target coating area A so as to receive dust or impurities, the particle suction pipeline 192 is in communication with the particle collecting container 191, and the fan group 193 is located at an opening of the particle collecting container 191. The filter device 20 may be a filter screen or a dust bag, and is arranged on one end of the particle suction pipeline 192. The particle discharge device 21 may be a pipeline having a dilated outlet.

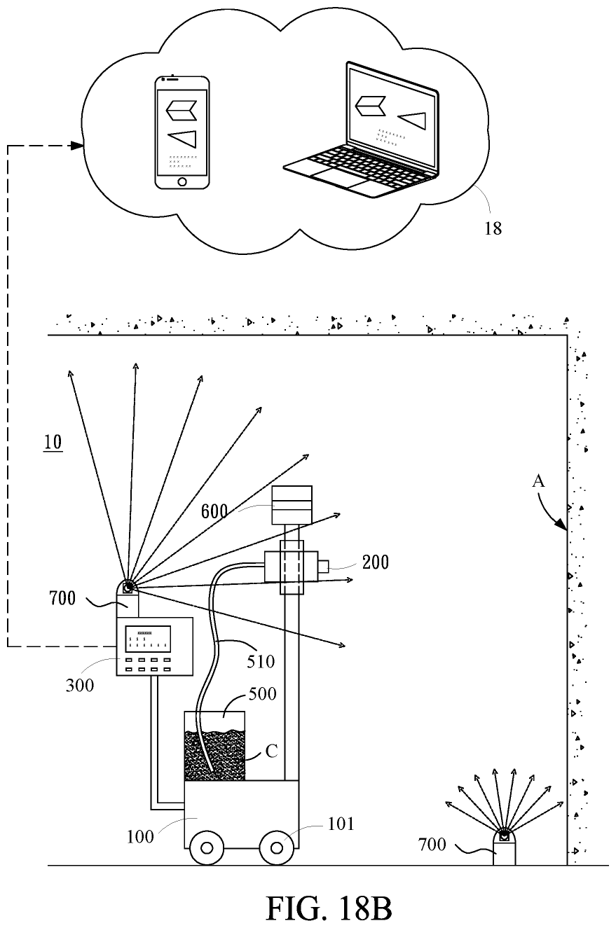

As shown in FIG. 20 and FIG. 1A, in one embodiment, the coating system 10 further includes an element 22. The element 22 is signally connected to the control device 300, and the motion section 101 is electrically connected to the control device 300. The control device 300 controls the motion section 101 to move according to a signal from the element 22. The element 22 may be a magnetic track, a track having a signal transmitting/receiving function, or an element having a signal receiving or transmitting function. For example, when the element 22 is a magnetic track, the carrier device 100 may also be provided with a magnetic device such as a magnet. The user may lay the element 22 on the floor in advance, and the carrier device 100 can then be guided by the element 22 and move by the motion section 101 (for example, a wheel). Thus, the carrier device 100 substantially moves on a route planned in advance by the element 22 and does not go out of control such as hitting against a wall. Moreover, when the carrier device 100 or the coating structure 200 is stationary, the control device 300 is adapted to constantly or intermittently control the carrier device 100 or the coating structure 200 to be kept at a predetermined distance from the target coating area A. When the carrier device 100 or the coating structure 200 is in motion, the control device 300 is adapted to constantly or intermittently control the carrier device 100 or the coating structure 200 to maintain a cruise distance from the target coating area A.

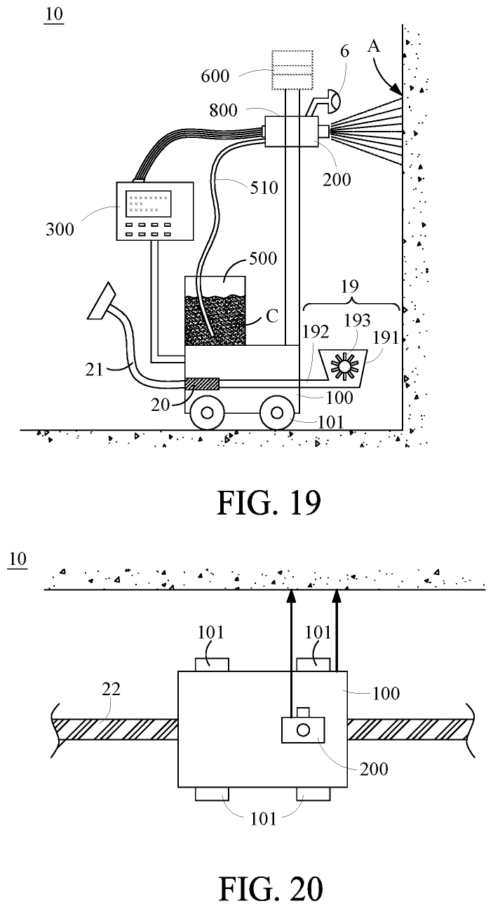

As shown in FIG. 21 and FIG. 6, in one embodiment, the coating system 10 further includes a first slide bar 170, a second slide bar 171 and a slide beam 172. The first slide bar 170 and the second slide bar 171 are connected to the carrier device 100 and are opposite to each other. Two ends of the slide beam 172 are respectively installed at the first slide bar 170 and the second slide bar 171, and the slide beam 172 is installed with the coating structure 200. The slide beam 172, the first slide bar 170 and the second slide bar 171 have respective slide tracks 173, each of both ends of the slide beam 172 is provided with a first slide block 174 installed at the slide track 173 of each of the first slide bar 170 and the second slide bar 171, and the coating structure 200 is provided with a second slide block 206 installed at the slide track 173 of the slide beam 172. However, the present invention is not limited to the examples above, and other sliding structures may also be adopted. The coating system 10 may further include a driving device, for example but not limited to, the servo motor 12 in FIG. 6. The driving device is electrically connected to the coating structure 200, the slide beam 172 and the control device 300, so as to control the slide beam 172 to move up and down along the first slide bar 170 or the second slide bar 171 or control the coating structure 200 to move laterally or longitudinally along the slide beam 172. In other embodiments that are not depicted by drawings, the driving device may also include a belt-driven device, gear-driven device, track-driven device, screw-driven device, drive rod-driven device, magnetically driven device, oil pressure-driven device or electrically-driven device. In this embodiment, for example but not limited to, the coating system 10 is provided with two coating structures 200 and two storage tanks 500 containing the coating material C are correspondingly provided. In this embodiment, the coating system 10 is provided with the identification device 6 shown in FIG. 16A to FIG. 16E on each of the first slide bar 170 and the second slide bar 171. In this embodiment, the alarm device 600 is provided on a top portion of each of the first slide bar 170 and the second slide bar 171. However, the present invention is not limited to the examples above. The coating system 10 may also include first slide bar 170 and the slide beam 172 only. The slide beam 172 may be installed at the first slide bar 170, and the slide beam 172 may have the coating structure 200 thereon or the slide beam 172 may be installed with the coating structure 200 thereon. Thus, the driving device can control the slide beam 172 to move up and down along the first slide beam 170 and to control the coating structure 200 to move laterally or longitudinally along the slide beam 172.

As shown in FIG. 21, in one embodiment, the coating system 10 may further include a push frame 102. The push frame 102 includes a connection section 103 connected to one side of the carrier device 100 and a handheld section 104 connected to the connection section 103. The connection section 103 may be a support and the handheld section 104 may be a handle. A user M may hold the handheld section 104 to push the carrier device 100 so as to provide mobility in order to coat different target coating areas. However, the push frame 102 is not limited to only the embodiment shown in FIG. 21 but is applicable to all the foregoing embodiments.

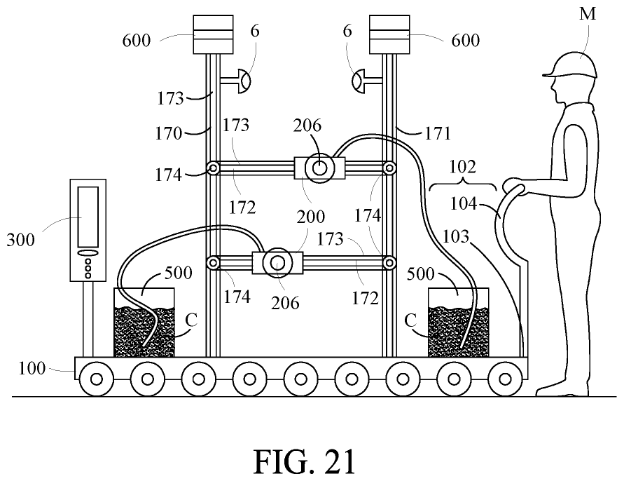

As shown in FIG. 1, FIG. 7, FIG. 16D and FIG. 22, the identification device 6 may perform continuous capturing of the planar target coating area A, and construct two-dimensional map or geographic information according to the images continuously captured. The identification device 6 may continuously capture a plurality of images in a capturing direction F1, for example, an image 901 and an image 902, wherein the image 901 and the image 902 are partially overlapping so as to comprehensively construct a two-dimensional model of the target coating area A. It should be noted that the present invention is not limited to the examples above. If the identification device 6 needs to move during the capturing process, the control device 300 may issue a motion instruction to the motion section 101, the motion mechanism 400 in the form of a slide bar or a mechanical arm, a pivotal mechanism of the identification device 6 with respect to the motion mechanism 400, or any combination of the motion mechanisms above.

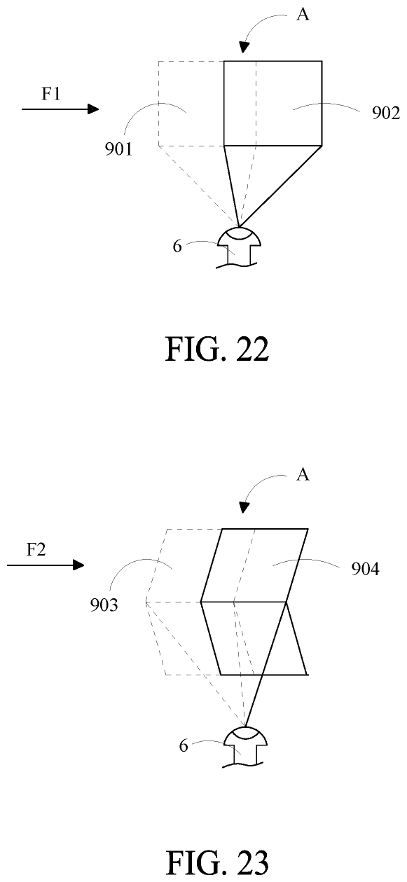

As shown in FIG. 1, FIG. 7, FIG. 16D and FIG. 23, the identification device 6 may also perform continuous capturing of the target coating area A having the first plane P1 and the second plane P2, and construct three-dimensional map or geographic information according to the images obtained from the continuous capturing. The identification device 6 may continuously capture a plurality of images in a capturing direction F2, for example, an image 903 and an image 904, wherein the image 903 and the image 904 are partially overlapping so as to comprehensively construct a three-dimensional model of the target coating area A.

The present invention is described by way of the preferred embodiments above. A person skilled in the art should understand that, these embodiments are merely for describing the present invention and are not to be construed as limitations to the scope of the present invention. It should be noted that all equivalent changes, replacements and substitutions made to the embodiments are encompassed within the scope of the present invention. Therefore, the scope of legal protection of the present invention should be defined by the appended claims.

What is claimed is:

1. A coating system for a construction work or a construction site, applied for coating a target coating area of the construction work with a coating material, the coating system comprising:
a carrier device;
a coating structure, movably arranged on the carrier device; and
a control device, controlling the coating structure, the control device having information corresponding to the target coating area and for driving the coating structure according to the information to coat the target coating area with the coating material.

2. The coating system of claim 1, wherein the control device is electrically connected to the coating structure, and the information that the control device has corresponding to the target coating area is coating information.

3. The coating system of claim 1, further comprising a motion mechanism connected on the carrier device, wherein the coating structure is connected to the motion mechanism.

4. The coating system of claim 3, wherein the motion mechanism is a slide bar to which the coating structure is slidably connected, and under driving of the control device, the coating structure moves vertically on the carrier device; alternatively, the motion mechanism is a mechanical arm electrically connected to the control device, and the coating structure moves via the mechanical arm.

5. The coating system of claim 1, further comprising a servo motor electrically connected to the control device and the coating structure.

6. The coating system of claim 1, wherein a motion section is provided on a bottom portion of the carrier device to cause the carrier device to move according to path requirements of use.

7. The coating system of claim 6, further comprising an element that is in a signal connection with the control device, wherein the motion section is controlled by the control device, and the control device controls the motion section to move via the signal connection with the element.

8. The coating system of claim 7, wherein the element is a magnetic track, a track having a signal transmitting/receiving function, or an element having a signal receiving or transmitting function.

9. The coating system of claim 1, further comprising at least one scanning or positioning device connected to the control device so as to scan and obtain map or geographic information of the target coating area, and the control device is configured to recognize the map or geographic information provided by the scanning or positioning device so as to send an instruction to the coating structure to perform coating.

10. The coating system of claim 1, further comprising at least one scanning or positioning device connected to the control device so as to scan and obtain information of the target coating area, wherein the information is map or geographic information, and the control device is configured to recognize the map or geographic information provided by the scanning or positioning device so as to send an instruction to the coating structure to perform coating; the scanning or positioning device is a two-dimensional scanning or position device and the map or geographic information is two-dimensional map or geographic information; alternatively, the scanning or positioning device is a three-dimensional scanning or positioning device and the map or geographic information is three-dimensional map or geographic information.

11. The coating system of claim 1, further comprising at least one scanning or positioning device signally connected to the control device so as to scan and obtain information of the target coating area, wherein the information is map or geographic information, the control device is configured to recognize the map or geographic information so as to send an instruction to the coating structure to perform coating, and the scanning or positioning device is for identifying whether the target coating area has been coated.

12. The coating system of claim 1, further comprising one or more position information sensors configured on one or more positions of the target coating area, wherein the control device is signally connected to the position information sensor so as to construct the information, and the information is map or geographic information.

13. The coating system of claim 12, wherein the target coating area comprises a non-planar area, and the individual position information sensors are arranged on at least one surface or surfaces of at least two different angles in the non-planar area.

14. The coating system of claim 1, wherein the coating structure is rotatable relative to the carrier device so as to coat the target coating area comprising a planar or non-planar area.

15. The coating system of claim 1, further comprising one or more position information sensors configured on one or more different positions of the target coating area, wherein the control device is signally connected to the position information sensor so as to construct the information, and the information is map or geographic information; alternatively, the individual position information sensors have constructed the map or geographic information with the control device before the coating structure performs coating, or have been removed from the target coating area before the coating structure performs coating.

16. The coating system of claim 1, further comprising an identification device, wherein the identification device determines whether the target coating area has been coated and sends a message to the control device, the control device recognized the message provided by the identification device and then issues an instruction to the coating structure, and the coating structure coats the target coating area according to the instruction.

17. The coating system of claim 1, further comprising an identification device, wherein the identification device determines whether the target coating area has been coated and sends a message to the control device, the control device recognized the message provided by the identification device and then issues an instruction to the coating structure, the coating structure coats the target coating area according to the instruction, and the identification device determines whether the target coating area has been coated or an expected coating effect has been achieved by identifying a pattern, color, material, coating density or coating thickness of the target coating area.

18. The coating system of claim 1, further comprising an identification device, wherein the identification device determines whether the target coating area has been coated and sends a message to the control device, the control device recognized the message provided by the identification device and then issues an instruction to the coating structure, the identification device comprises an image determination device, a scanning device or a combination thereof, and the image determination device is for identifying a pattern or color of the target coating area, or the scanning device is for identifying a material, coating density or coating thickness of the target coating area.

19. The coating system of claim 1, further comprising an identification device, wherein the identification device determines whether the target coating area has been coated and sends a message to the control device, the control device recognized the message provided by the identification device and then issues an instruction to the coating structure, the coating structure coats the target coating area according to the instruction, the identification device comprises a scanning device, and the scanning device comprises an active or passive identification device, an active or passive infrared identification device, a microwave identification device, a radar identification device or a magnetic identification device.

20. The coating system of claim 1, further comprising an elimination device and an identification device, wherein the identification device determines whether the target coating area has been coated and sends a message to the control device, the control device recognized the message provided by the identification device and then issues an instruction to the coating structure, the coating structure coats the target coating area according to the instruction, and the elimination device is arranged around the identification device and is adapted to eliminate a substance that may affect identification performed by the identification device from the target coating area.

21. The coating system of claim 1, further comprising an identification device, wherein the identification device determines whether the target coating area has been coated and sends a message to the control device, the control device recognized the message provided by the identification device and then issues an instruction to the coating structure, the coating structure coats the target coating area according to the instruction, and the identification device is rotatable by 0 to 360 degrees or an identifiable angle of the identification device is 0 to 360 degrees.

22. The coating system of claim 1, further comprising a particle suction device for sucking dust or a substance in the air in an ambient environment of the target coating area.

23. The coating system of claim 22, further comprising a particle discharge device or a combination comprising the particle discharge device and a filter device, wherein the particle discharge device is in communication with the particle suction device, and the filter device is arranged between the particle suction device and the particle discharge device.

24. The coating system of claim 1, further comprising an alarm device arranged on the carrier device and electrically connected to the control device, wherein the alarm device is for issuing a warning light or sound when the coating system malfunctions.

25. The coating system of claim 1, further comprising a storage tank and a pipeline connecting between the storage tank and the coating structure, wherein the storage tank is for storing the coating material and supplying the coating material to the coating structure through the pipeline.

26. The coating system of claim 1, further comprising a flattening device connected to the control device, wherein the flattening device is for flattening the coating material in the target coating area after the coating structure completes coating.

27. The coating system of claim 26, further comprising a scraping device, wherein the scraping device is for scraping off excess coating material on the flattening device when the flattening device completes flattening the coating material.

28. The coating system of claim 27, further comprising a receiving device, wherein the receiving device is for receiving the coating material scraped off.

29. The coating system of claim 1, wherein the coating structure is a brush coating structure comprising a brush for applying the coating material, the coating system further comprises a storage tank and a pipeline connecting between the storage tank and the brush, and the storage tank is for storing the coating material and transporting the coating material to the brush through the pipeline; alternatively, the coating structure further comprises a feed tank, the feed tank is located below the brush, and the brush enters the feed tank and is dipped with the coating material so as to coat the target coating area.

30. The coating system of claim 1, wherein the coating system is a rolling coating structure comprising a roller for applying the coating material, and the coating system further comprises a feed tank and a pipeline connecting between the feed tank and the roller, and the feed tank is for storing the coating material and transporting the coating material to the roller through the pipeline; alternatively, the coating system further comprises a feed plate located on one end of the pipeline and arranged above the roller.

31. The coating system of claim 1, further comprising a first slide bar, a second slide bar and a slide beam, the first slide bar and the second slide bar are connected to the carrier device and are opposite to each other, two ends of the slide beam are respectively installed at the first slide bar and the second slide bar, and the slide beam has the coating structure thereon or the slide beam is installed with the coating structure thereon.

32. The coating system of claim 1, further comprising a first slide bar and a slide beam, the slide beam is installed at the first slide bar, and the slide beam has the coating structure thereon or the slide beam is installed with the coating structure thereon.

33. The coating system of claim 32, wherein the slide beam, the first slide bar and the second slide bar have respective slide tracks, each of both ends of the slide beam is provided with a first slide block installed at the slide track of each of the first slide bar and the second slide bar, and the coating structure is provided with a second slide block installed at the slide track of the slide beam.

34. The coating system of claim 32, further comprising a driving device electrically connected to the coating structure, the slide beam and the control device, so as to control the slide beam to move up and down along the first slide bar or the second slide bar and to control the coating structure to move laterally or longitudinally along the slide beam.

35. The coating system of claim 1, further comprising a push frame, wherein the push frame comprises a connection section connected to one side of the carrier device and a handheld section connected to the connection section.

36. The coating system of claim 1, wherein the control device is for controlling the coating structure to perform matrix movement, longitudinal movement, lateral movement or rotational movement, the carrier device is located at a current position while the coating structure coats the target coating area, and the carrier device is adapted to be moved to another current position once the coating structure completes a coating task on the target coating area, so that the coating structure coats another target coating area; alternatively, the control device is for controlling the carrier structure to move among different current positions in response to a coating sequence of the coating structure corresponding to different target coating areas.

37. The coating system of claim 1, wherein the carrier device is located at a current position while the coating structure coats the target coating area, and the carrier device is adapted to be moved to another current position once the coating structure completes a coating task on the target coating area, so that the coating structure coats another target coating area.

38. The coating system of claim 1, further comprising an identification device, wherein the identification device is for capturing a plurality of images of the target coating area, the images are partially overlapping or non-overlapping with one another so as to construct the information according to the images, and the information is two-dimensional or three-dimensional map or geographic information.

39. The coating system of claim 1, wherein the control device is installed with software for controlling a spray coating amount, spray coating speed or spray coating thickness of the coating material spray coated by the coating structure to the target coating area; alternatively, the control device is signally connected to a remote device, the remote device is a computer or a mobile device, the remote device is installed with software, and the remote device is installed with an application for controlling the software.

40. The coating system of claim 1, wherein a structure of a coating exit of the coating structure is for controlling a coating range or coating width of the coating material for coating.

41. The coating system of claim 1, wherein the control device is for controlling the coating structure to perform matrix movement, longitudinal movement, lateral movement or rotational movement, the coating structure is located at a current position while it coats the target coating area, and the coating structure is adapted to be moved to another current position once it completes a coating task on the target coating area, so that the coating structure coats another target coating area; alternatively, the control device is for controlling the coating structure to move among different current positions in response to a coating sequence corresponding to different target coating areas.

42. The coating system of claim 1, wherein the coating structure is located at a current position while it coats the target coating area, and the coating structure is adapted to be moved to another current position once it completes a coating task on the target coating area, so that the coating structure coats another target coating area.

43. The coating system of claim 1, wherein the control device is for synchronously controlling the coating structure and the carrier device to perform matrix movement, longitudinal movement, lateral movement or rotational movement, the coating structure and the carrier device are located at a current position while the coating structure coats the target coating area, and the coating structure and the carrier device are adapted to be moved to another current position once they complete a coating task on the target coating area, so that the coating structure and the carrier device coat another target coating area; alternatively, the control device is for controlling the carrier device and the coating structure to move among different current positions in response to a coating sequence of the coating structure corresponding to different target coating areas.

44. The coating system of claim 1, wherein the control device is for controlling the coating device to perform matrix movement, longitudinal movement, lateral movement or rotational movement.

45. The coating system of claim 1, wherein when the carrier device or the coating device is still, the control device is adapted to constantly or intermittently control the carrier device or the coating device to be kept at a predetermined distance from the target coating area; alternatively, when the carrier device or the coating structure is in motion, the control device is adapted to constantly or intermittently control the carrier device or the coating device to maintain a cruise distance from the target coating area.

46. The coating system of claim 1, wherein the coating material comprises water-based paint, oil-based paint, cement, resin, glue, Teflon, oil, paint, colored material, colorless material or asphalt, or other liquid or semi-liquid paint.

47. A method of use of a coating system for a construction work or a construction site, using a coating system to coat a target coating area of the construction work with a coating material, the coating system comprising a carrier device, a coating structure movably arranged on the carrier device and a control device for controlling the coating structure, the method of use comprising:
obtaining information of the target coating area by the control device; and
driving the coating structure according to the information to coat the target coating area with the coating material.
